(19) United States
(12) Patent Application Publication
(10) Pub. No.: US 2016/0275077 A1
(43) Pub. Date: Sep. 22, 2016

(54) Method and apparatus for automatically sending multimedia file, mobile terminal, and storage medium

(71) Applicant: ZTE CORPORATION, Shenzhen, Guangdong (CN)

(72) Inventor: Weixin Zhang, Shenzhen (CN)

(21) Appl. No.: 15/029,598

(22) PCT Filed: Mar. 31, 2014
(86) PCT No.: PCT/CN2014/074478

§ 371 Date: Apr. 14, 2016

(30) Foreign Application Priority Data
Oct. 14, 2013 (CN) 201310478418.9

(51) Int. Cl. G06F 17/30; G06F 3/16

(52) U.S. Cl. CPC G06F 17/30026; G06F 3/165

(57) ABSTRACT

A method for automatically sending a multimedia file comprises: obtaining a voice feature of each object in a multimedia file (101); matching the obtained voice feature of each object with a voice feature of each contact in a voice parameter database (102); and when matching succeeds, automatically sending the multimedia file to a contact obtained by successful matching (103). Further disclosed are an apparatus for automatically sending a multimedia file, a mobile terminal, and a storage medium.

### TECHNICAL FIELD

The disclosure relates to a multimedia file transmission technology, and in particular to a method and apparatus for automatically sending a multimedia file, a mobile terminal and a storage medium.

### BACKGROUND

With the popularisation of intelligent mobile terminals, the coming of a 3G/E3G era and the launching of various applications, the combination of mobile internet and cable internet is continuously accelerated, and the internet has trended towards various mobile terminals such as mobile phones and other mobile devices from desktop Personal Computers (PC). The mobile internet can meet requirements of users for conveniently enjoying internet service on the way between home and office, on a trip, at waiting time and at outdoor entertainment time, and bring great convenience to the work and life for people.

In the conventional art, when a multimedia file is sent via messaging or internet, it is necessary to add contact information of file receivers one by one. Here, the multimedia file may be a data file, an audio file or a video file. When there are more file receivers, a sending user needs to spend a lot of time searching and adding contacts, thereby influencing the using experience of the user and bringing inconvenience to the life of the user.

### SUMMARY

In view of this, the embodiments of the disclosure provide a method and apparatus for automatically sending a multimedia file, a mobile terminal and a storage medium, which can achieve automatic sending of the multimedia file, save the time of a user and improve the using experience of the user.

To this end, the technical solutions of the disclosure are implemented as follows.

An embodiment of the disclosure provides a method for automatically sending a multimedia file, which may include that:

a voice feature of each object in the multimedia file is obtained; a match is searched for between the obtained voice feature of each object and a voice feature of each contact in a voice parameter database; and when a match is found, the multimedia file is automatically sent to a matching contact.

In an embodiment, the method may further include that: before the voice feature of each object in the multimedia file is obtained, it is pre-set whether a functional mode of automatically sending the multimedia file is activated.

In an embodiment, the step that the voice feature of each object in the multimedia file is obtained may include that: a voice signal of the multimedia file is extracted and analysed, and the analysed voice signal is output in a frequency form.

In an embodiment, the step that the voice feature of each object in the multimedia file is obtained may include that: the input multimedia file is divided into segments in a time domain, and a time domain signal corresponding to a voice in each segment of file is converted into a respective frequency domain signal; a corresponding voice feature is obtained from the obtained frequency domain signal of the voice; the obtained voice feature of each object is identified by an index and the voice feature identified by the index is stored; and upon completion of a voice feature analysis, a sequence array formed by indexes to voice features is output.

In an embodiment, when there are multiple matching contacts, the method may further include that: a contact needing to receive the multimedia file is selected, and the multimedia file is sent to the selected contact.

In an embodiment, the step that the multimedia file is automatically sent to the matching contact may include that: when a data service state of a mobile terminal is activated, the multimedia file is automatically sent to the matching contact in a data service manner preferentially; and when the data service state of the mobile terminal is not activated, the multimedia file is automatically sent to the matching contact in an messaging manner.

An embodiment of the disclosure provides an apparatus for automatically sending a multimedia file, which may include: a voice processing module, a voice parameter database, a voice parameter matching module and a sending module, wherein

the voice processing module is configured to obtain a voice feature of each object in the multimedia file;

the voice parameter database is configured to store voice features of contacts;

the voice parameter matching module is configured to search for a match between the voice feature of each object in the multimedia file and the voice feature of each contact in the voice parameter database; and

the sending module is configured to automatically send the multimedia file to a matching contact when a match is found.

In an embodiment, the apparatus may further include: a setting module, configured to pre-set whether a functional mode of automatically sending the multimedia file is activated.

In an embodiment, the apparatus may further include: a selection module, configured to, when there are multiple matching contacts, select a contact needing to receive the multimedia file and trigger the sending module.

An embodiment of the disclosure also provides a mobile terminal, which may include any above-mentioned apparatus for automatically sending a multimedia file.

An embodiment of the disclosure also provides a computer storage medium. Computer programs are stored in the computer storage medium and are used for executing the method for automatically sending a multimedia file according to the embodiment of the disclosure.

By means of the method and apparatus for automatically sending a multimedia file, the mobile terminal and the storage medium, provided by the embodiments of the disclosure, the voice feature of each object in the multimedia file is obtained; a match is searched for between the obtained voice feature of each object and the voice feature of each contact in the voice parameter database; and when a match is found, the multimedia file is automatically sent to all matching contacts. The embodiments of the disclosure can achieve automatic sending of the multimedia file, save the time of a user, reduce the communication cost of the user, improve the using experience of the user and bring convenience to the life of the user.

### BRIEF DESCRIPTION OF THE DRAWINGS

FIG. 1 is a basic processing flowchart of a method for automatically sending a multimedia file according to an embodiment of the disclosure;

FIG. 2 is a specific implementation flowchart of a method for automatically sending a multimedia file according to an embodiment of the disclosure;

FIG. 3 is a specific implementation flowchart of obtaining of a voice feature of each object in a multimedia file via a mobile terminal according to an embodiment of the disclosure; and

FIG. 4 is a composition structure diagram of an apparatus for automatically sending a multimedia file according to an embodiment of the disclosure.

### DETAILED DESCRIPTION

Computer voice recognition is a mode recognition matching process. In this process, firstly, it is necessary for a computer to establish a voice model according to a voice feature of an obtained object, to analyse an input voice signal, to extract required characteristics, and to establish a template required for voice recognition on this basis. And the computer compares a voice template stored in the computer with characteristics of the input voice signal according to an overall voice recognition model in the recognition process and finds a series of optimal templates matching an input voice according to a certain searching and matching policy. Then, a recognition result of the computer can be obtained by table look-up according to definitions of found template numbers.

By utilizing characteristics/features of the voice recognition, in various embodiments of the disclosure, a voice feature of each object in a multimedia file is obtained; a match is searched for between the voice feature of each object and a voice feature of each contact in a voice parameter database; and when a match is found, the multimedia file is automatically sent to a matching contact.

Here, objects are in one-to-one correspondence to contacts, and one or more contacts may be probably involved in a multimedia file. When one object is involved, a match is searched for between the voice feature of the object and the voice feature of each contact in the voice parameter database. And when a match is found, the multimedia file is automatically sent to the matching contact. When multiple objects are involved, a match is searched for between the voice feature of each object and the voice feature of each contact in the voice parameter database. After a match is found, corresponding matching contacts are recorded, and after the match searching with respect to multiple contacts is completed, as long as matches are found, the multimedia file is automatically sent to the matching contact In this situation, the multimedia file can be sent to all of the matching contacts or selectively sent to part of the matching contacts.

Specifically, when a user needs to send a multimedia file, a mobile terminal obtains the voice feature of each object in the multimedia file to be sent, including: extracting and analysing a voice signal of the multimedia file in a time domain, and outputting the analysed voice signal in a frequency form. The voice signal is converted from the time domain to a frequency domain, to further obtain the voice feature of each object involved in the multimedia file to be sent.

Herein, the voice features includes energy, amplitude, a zero-crossing rate, a frequency spectrum, a cepstrum, a power spectrum and the like, and a voice recognition parameter includes a Linear Prediction Coefficient (LPC), a Linear Prediction Cepstrum Coefficient (LPCC), a Mel Frequency Cepstrum Coefficient (MFCC) and the like.

In practical applications, when a data service state of a mobile terminal is activated, the multimedia file is automatically sent to the matching contact in a data service manner preferentially. And when the data service state of the mobile terminal is not activated, the multimedia file is automatically sent to the matching contact in an messaging manner such as multimedia message service.

Here, the voice feature of each object corresponds to a unique contact, and the voice feature of each contact in the voice parameter database can be pre-stored, retained in a voice call, extracted from an existing multimedia file, or be obtained in other modes capable of obtaining the voice feature and saved.

Furthermore, it can be pre-set whether a functional mode of automatically sending the multimedia file is activated. A function of automatically sending the multimedia file is activated as needed. If the function of automatically sending the multimedia file is activated, a match is searched for between the obtained voice feature of each object in the multimedia file and the voice feature of each contact in the voice parameter database, and the multimedia file is automatically sent to a matching contact.

It is important to note that the mobile terminal in the embodiment of the disclosure is not limited to a smart phone and a Personal Digital Assistant (PDA), and all mobile terminals having file storage and communication functions can be applied to a method for automatically sending a multimedia file according to the embodiment of the disclosure, and shall fall within a range of mobile terminals to be protected by the embodiment of the disclosure.

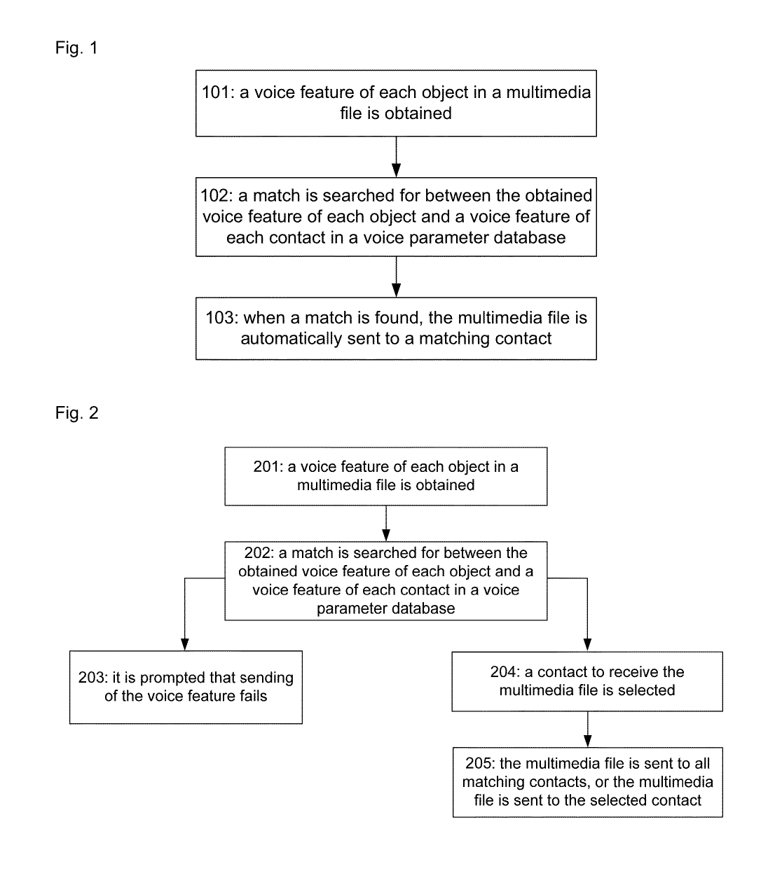

As shown in FIG. 1, a basic processing flow of a method for automatically sending a multimedia file according to an embodiment of the disclosure includes the steps as follows.

Step 101: a voice feature of each object in a multimedia file is obtained.

Here, the step that a mobile terminal obtains the voice feature of each object in the multimedia file includes that: a voice signal of the multimedia file is extracted and analysed, the analysed voice signal is output in a frequency form, and the voice feature of each person involved in the multimedia file is further obtained.

Step 102: a match is search for between the obtained voice feature of each object and a voice feature of each contact in a voice parameter database.

Here, there is a unique match between the voice feature of each object and the voice feature of a contact in the voice parameter database uniquely; and moreover, the voice feature of each contact in the voice parameter database is pre-stored, can be obtained from an audio file of an ordinary communication, can be obtained from an existing audio file, or can be obtained in other modes capable of obtaining the voice feature and saved.

When multiple objects are involved, a match is searched for between the voice feature of each of the multiple objects and voice features of contacts in the voice parameter database.

Step 103: When a match is found, the multimedia file is automatically sent to a matching contact.

Here, when there are multiple matching contacts, the multimedia file can be sent to all matching contacts, or a contact needing to receive the multimedia file can be selected, and the multimedia file is sent to the selected contact.

Specifically, when a data service state of a mobile terminal is activated, the multimedia file will be automatically sent to the contact needing to receive the multimedia file in a data service manner such as Wechat, QQ and Email preferentially; and when the data service state of the mobile terminal is not activated or the mobile terminal is not in the data service state, the multimedia file is automatically sent to the contact needing to receive the multimedia file in a Packet Switch (PS) domain messaging manner such as short messaging and multimedia message service.

In the process, prior to Step 101, the method further includes that: before the mobile terminal obtains the voice feature of each person in the multimedia file, it is pre-set whether a functional mode of automatically sending the multimedia file is activated.

Specifically, when a function of automatically sending the multimedia file is activated as needed. If the function of automatically sending the multimedia file is activated, automatic sending of the multimedia file can be achieved when a file is selectively sent.

The technical solutions of the embodiments of the disclosure are further described in detail below with reference to the drawings and specific embodiments.

As shown in FIG. 2, a specific implementation flow of a method for automatically sending a multimedia file according to an embodiment of the disclosure includes the steps as follows.

Step 201: A voice feature of each object in a multimedia file is obtained.

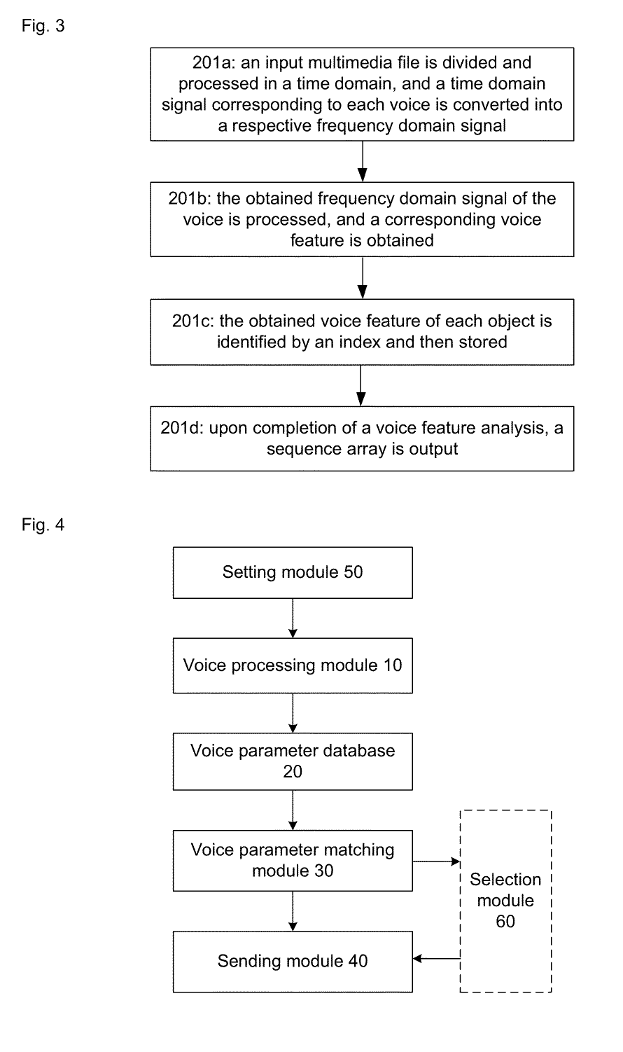

As shown in FIG. 3, a specific implementation flow of obtaining of a voice feature of each object in a multimedia file according to an embodiment of the disclosure includes the steps as follows.

Step 201a: An input multimedia file is divided into segments in a time domain, and a time domain signal corresponding to a voice in each segment of file is converted into a respective frequency domain signal.

Here, the input multimedia file can be divided into N segments according to the time domain, wherein an interval between every two segments can be set as 0.5 s, 1 s or the like as needed. A voice signal of the multimedia file is pre-processed according to a traditional acoustic characteristic extraction method involving a frequency domain, wherein pre-processing includes pre-emphasis on the voice signal, and a high-quality voice frequency spectrum is further obtained. A commonly captured voice signal frequency is located between 1.5 kHz and 1.6 kHz; and moreover, the voice is captured according to the time domain in the situation that each voice has only one object, if two or more objects occur in the same voice simultaneously, it is difficult to distinguish different objects, and voice signals cannot be captured to be compared.

Step 201b: A corresponding voice feature is obtained from the obtained frequency domain signal of the voice.

Specifically, the obtained voice feature includes energy, amplitude, a zero-crossing rate, a frequency spectrum, a cepstrum, a power spectrum and the like, and a corresponding voice recognition parameter such as an LPC, an LPCC and an MFCC is obtained using the obtained voice feature.

Here, the voice feature extraction method is the conventional art, detailed descriptions are not needed, and all conventional voice feature extraction methods are applicable to the embodiments of the disclosure.

Step 201c: the obtained voice feature of each object identified by an index and then stored.

The obtained voice feature of each object is identified by an index as: Index1 (voice feature 1), Index2 (voice feature 2), Index3 (voice feature 3) and the like, contents with the same Index are filtered, and a unique Index is retained and stored to ensure that each feature corresponds to a unique contact in a voice parameter database.

Here, voices in all segments of multimedia file divided in Step 201a correspond to different or identical objects respectively, and the voice feature of each object can be obtained after each segment of multimedia file is processed.

Step 201d: upon completion of a voice feature analysis, a sequence array formed by indexes and identifiers is output.

Here, the output sequence array is: Index1 (voice feature 1), Index2 (voice feature 2), Index3 (voice feature 3) and the like.

Step 202 to Step 203: a match is searched for between the obtained voice feature of each object and a voice feature of each contact in the voice parameter database.

Here, there is a unique match between the obtained voice feature of each object and the voice feature of each contact in the voice parameter database uniquely; and moreover, the voice feature of each contact in the voice parameter database is pre-stored, can be retained in a voice call, can be extracted from an existing multimedia file, or can be obtained in other modes capable of obtaining the voice feature and saved.

When no match is found between the voice feature of each object in the multimedia file and the voice feature of each contact in the voice parameter database fails, Step 203 is executed, it is prompted that sending of the voice feature fails, and a current flow is ended.

When one matching contact is found, Step 205 is directly executed. When multiple matching contacts are found, it is prompted that a contact needing to receive the multimedia file is required to be selected, and Step 204 is executed.

Step 204: a contact to receive the multimedia file is selected.

Here, if there is no selection, all matching contacts can be selected by default.

Step 205: The multimedia file is sent to all the matching contacts, or the multimedia file is sent to the selected contact.

Specifically, when a mobile terminal activates a data service state, the multimedia file will be automatically sent to the contact needing to receive the multimedia file in a data service manner such as Wechat, QQ and Email preferentially; and

when the data service state of the mobile terminal is not activated or the mobile terminal is not in the data service state, the multimedia file is sent to the matching contact in a PS domain messaging manner such as short messaging and multimedia message service.

Here, prior to Step 201, the method further includes that: before the mobile terminal obtains the voice feature of each object in the multimedia file, it is pre-set whether a functional mode of automatically sending the multimedia file is activated.

In order to implement the method for automatically sending a multimedia file, an embodiment of the disclosure also provides an apparatus for automatically sending a multimedia file. The apparatus for automatically sending a multimedia file is arranged in a mobile terminal and belongs to newly added functional modules of the mobile terminal. FIG. 4 shows a composition structure of the apparatus for automatically sending a multimedia file. The apparatus includes: a voice processing module 10, a voice parameter database 20, a voice parameter matching module 30 and a sending module 40, wherein

the voice processing module 10 is configured to obtain a voice feature of each object in the multimedia file;

the voice parameter database 20 is configured to store voice features of contacts;

the voice parameter matching module 30 is configured to search for a match between the voice feature of each object in the multimedia file and the voice feature of each contact in the voice parameter database; and

the sending module 40 is configured to send the multimedia file to a matching contact.

Here, the matching contact can be all matching contacts or can be some selected matching contacts.

The apparatus may further include: a setting module 50, configured to pre-set whether a functional mode of automatically sending the multimedia file is activated.

Here, the set functional mode of automatically sending the multimedia file is activated as needed.

The apparatus may further include: a selection module 60, configured to select a contact needing to receive the multimedia file and trigger the sending module when there are multiple matching contacts.

Correspondingly, the voice parameter matching module 30 prompts a result of the match searching made between the voice feature of each object in the multimedia file and the voice feature of each contact in the voice parameter database.

Furthermore, an embodiment of the disclosure also provides a mobile terminal, which includes the apparatus for automatically sending a multimedia file.

The voice parameter database in the apparatus for automatically sending a multimedia file, proposed in the embodiment of the disclosure, can be implemented via a storage device such as a hard disk. The voice processing module, the database, the voice parameter matching module, the sending module, the setting module and the selection module can be implemented via a processor, and can be implemented via a specific logical circuit certainly. The processor may be a processor for a mobile terminal or a server. In practical application, the processor may be a Central Processing Unit (CPU), a Micro Processor Unit (MPU), a Digital Signal Processor (DSP) or a Field-Programmable Gate Array (FPGA).

In the embodiments of the disclosure, if the method for automatically sending a multimedia file is implemented in a form of a software function module and is sold or used as an independent product, the product can also be stored in a computer readable storage medium. Based on this understanding, the technical solutions of the embodiments of the disclosure can be substantially embodied in a form of a software product or parts contributing to the conventional art can be embodied in a form of a software product, and the computer software product is stored in a storage medium, which includes a plurality of instructions enabling a computer device which may be a personal computer, a server or a network device to execute all or part of the method according to each embodiment of the disclosure. The storage medium includes: various media capable of storing program codes, such as a U disk, a mobile hard disk, a Read Only Memory (ROM), a disk or an optical disc. Thus, the embodiments of the disclosure are not limited to combination of any specific hardware and software.

Correspondingly, an embodiment of the disclosure also provides a computer storage medium. Computer programs are stored in the computer storage medium and are used for executing the method for automatically sending a multimedia file according to the embodiment of the disclosure.

The above is only the preferred embodiments of the disclosure and is not intended to limit the protection scope of the disclosure.

What is claimed is:

1. A method for automatically sending a multimedia file, comprising:
obtaining a voice feature of each object in the multimedia file, searching for a match between the obtained voice feature of each object and a voice feature of each contact in a voice parameter database, and when a match is found, automatically sending the multimedia file to a matching contact.

2. The method for automatically sending a multimedia file according to claim 1, further comprising:
pre-setting whether a functional mode of automatically sending the multimedia file is activated before the voice feature of each object in the multimedia file is obtained.

3. The method for automatically sending a multimedia file according to claim 1, wherein obtaining the voice feature of each object in the multimedia file comprises:
extracting and analysing a voice signal of the multimedia file, and outputting the analysed voice signal in a frequency form.

4. The method for automatically sending a multimedia file according to claim 1, wherein obtaining the voice feature of each object in the multimedia file comprises:
dividing the input multimedia file into segments in a time domain, and converting a time domain signal corresponding to a voice in each segment of file into a respective frequency domain signal;
obtaining a corresponding voice feature from the obtained frequency domain signal of the voice;
identifying the obtained voice feature of each object by an index and storing the voice feature identified by the index; and upon completion of a voice feature analysis, outputting a sequence array formed by indexes to voice features.

5. The method for automatically sending a multimedia file according to claim 1, wherein when there are multiple matching contacts, the method further comprises: selecting a contact needing to receive the multimedia file, and sending the multimedia file to the selected contact.

6. The method for automatically sending a multimedia file according to claim 1, wherein automatically sending the multimedia file to the matching contact comprises:
when a data service state of a mobile terminal is activated, automatically sending the multimedia file to the matching contact in a data service manner preferentially; and
when the data service state of the mobile terminal is not activated, automatically sending the multimedia file to the matching contact in a messaging manner.

7. An apparatus for automatically sending a multimedia file, comprising: a voice processing module, a voice parameter database, a voice parameter matching module and a sending module, wherein
the voice processing module is configured to obtain a voice feature of each object in the multimedia file;
the voice parameter database is configured to store voice features of contacts;
the voice parameter matching module is configured to search for a match between the voice feature of each object in the multimedia file and the voice feature of each contact in the voice parameter database; and
the sending module is configured to automatically send the multimedia file to a matching contact when a match is found.

8. The apparatus for automatically sending a multimedia file according to claim 7, further comprising:
a setting module, configured to pre-set whether a functional mode of automatically sending the multimedia file is activated.

9. The apparatus for automatically sending a multimedia file according to claim 7, further comprising:
a selection module, configured to, when there are multiple matching contacts, select a contact needing to receive the multimedia file and trigger the sending module.

10. A mobile terminal, comprising an apparatus for automatically sending a multimedia file, the apparatus comprising:
a voice processing module configured to obtain a voice feature of each object in the multimedia file;
a voice parameter database configured to store voice features of contacts;
a voice parameter matching module configured to search for a match between the voice feature of each object in the multimedia file and the voice feature of each contact in the voice parameter database; and
a sending module configured to automatically send the multimedia file to a matching contact when a match is found.

11. A computer storage medium having stored therein computer executable instructions configured to execute a method for automatically sending a multimedia file, the method comprising:
obtaining a voice feature of each object in the multimedia file, searching for a match between the obtained voice feature of each object and a voice feature of each contact in a voice parameter database, and when a match is found, automatically sending the multimedia file to a matching contact.

12. The method for automatically sending a multimedia file according to claim 2, wherein obtaining the voice feature of each object in the multimedia file comprises:
extracting and analysing a voice signal of the multimedia file, and outputting the analysed voice signal in a frequency form.

13. The method for automatically sending a multimedia file according to claim 2, wherein obtaining the voice feature of each object in the multimedia file comprises:
dividing the input multimedia file into segments in a time domain, and converting a time domain signal corresponding to a voice in each segment of file into a respective frequency domain signal;
obtaining a corresponding voice feature from the obtained frequency domain signal of the voice;
identifying the obtained voice feature of each object by an index and storing the voice feature identified by the index; and upon completion of a voice feature analysis, outputting a sequence array formed by indexes to voice features.

14. The method for automatically sending a multimedia file according to claim 2, wherein when there are multiple matching contacts, the method further comprises: selecting a contact needing to receive the multimedia file, and sending the multimedia file to the selected contact.

15. The method for automatically sending a multimedia file according to claim 2, wherein automatically sending the multimedia file to the matching contact comprises:
when a data service state of a mobile terminal is activated, automatically sending the multimedia file to the matching contact in a data service manner preferentially; and
when the data service state of the mobile terminal is not activated, automatically sending the multimedia file to the matching contact in a messaging manner.

16. The apparatus for automatically sending a multimedia file according to claim 8, further comprising:
a selection module, configured to, when there are multiple matching contacts, select a contact needing to receive the multimedia file and trigger the sending module.
